(19) United States
(12) Patent Application Publication
(10) Pub. No.: US 2025/0044443 A1
(43) Pub. Date: Feb. 6, 2025

(54) DETERMINATION DEVICE AND DETERMINATION METHOD

(71) Applicant: Panasonic Intellectual Property Management Co., Ltd., Osaka (JP)

(72) Inventors: Akihiro NODA, Osaka (JP); Taro IMAGAWA, Osaka (JP)

(21) Appl. No.: 18/919,704

(22) Filed: Oct. 18, 2024

Related U.S. Application Data
(63) Continuation of application No. PCT/JP2023/014213, filed on Apr. 6, 2023.

(30) Foreign Application Priority Data
Apr. 25, 2022 (JP) 2022-071595

(51) Int. Cl. G01S 13/88; G01S 7/41; G01S 13/06; G01S 13/89

(52) U.S. Cl. CPC G01S 13/887; G01S 7/417; G01S 13/06; G01S 13/89

(57) ABSTRACT

A determination device includes: an image obtainer that obtains an image based on a sub-terahertz wave that has irradiated a predetermined region; a subject information obtainer that obtains subject information including position information indicating a position of a subject located in the predetermined region and orientation information indicating an orientation of the subject; an intensity distribution information obtainer that obtains intensity distribution information indicating an intensity distribution in the predetermined region of the sub-terahertz wave that has irradiated the predetermined region; a determiner that determines whether a predetermined object is included in the subject, based on the image, the subject information, and the intensity distribution information; and an outputter that outputs a determination result determined by the determiner.

### CROSS REFERENCE TO RELATED APPLICATIONS

This is a continuation application of PCT International Application No. PCT/JP2023/014213 filed on Apr. 6, 2023, designating the United States of America, which is based on and claims priority of Japanese Patent Application No. 2022-071595 filed on Apr. 25, 2022. The entire disclosures of the above-identified applications, including the specifications, drawings and claims are incorporated herein by reference in their entirety.

### FIELD

The present disclosure relates to a determination device and a determination method for determining whether a predetermined object is included in a subject.

### BACKGROUND

Conventionally, there are known determination devices and the like that capture an image including a subject and use the captured image to determine whether a predetermined object is included in the subject. As an example of the determination devices and the like, Patent Literature (PTL) 1 discloses a processing system including: a first imaging system that captures a first image based on a terahertz wave from an inspection target; and a second imaging system that captures a second image of the inspection target, based on an electromagnetic wave having a wavelength different from the terahertz wave, wherein an inspection region is detected based on the second image, and information on a region of the first image corresponding to the inspection region is processed.

### CITATION LIST

### Patent Literature

PTL 1: Japanese Unexamined Patent Application Publication No. 2020-153975

### SUMMARY

### Technical Problem

Here, there is a need to more accurately determine whether a predetermined object is included in a subject.

Therefore, the present disclosure provides a determination device and the like capable of more accurately determining whether a predetermined object is included in a subject.

### Solution to Problem

A determination device according to one aspect of the present disclosure includes: an image obtainer that obtains an image based on a sub-terahertz wave that has irradiated a predetermined region; a subject information obtainer that obtains subject information including position information indicating a position of a subject located in the predetermined region and orientation information indicating an orientation of the subject; an intensity distribution information obtainer that obtains intensity distribution information indicating an intensity distribution in the predetermined region of the sub-terahertz wave that has irradiated the predetermined region; a determiner that determines whether a predetermined object is included in the subject, based on the image, the subject information, and the intensity distribution information; and an outputter that outputs a determination result determined by the determiner.

A determination method according to one aspect of the present disclosure includes: obtaining an image based on a sub-terahertz wave that has irradiated a predetermined region; obtaining subject information including position information indicating a position of a subject located in the predetermined region and orientation information indicating an orientation of the subject; intensity distribution information indicating an intensity distribution in the predetermined region of the sub-terahertz wave that has irradiated the predetermined region; determining whether a predetermined object is included in the subject, based on the image, the subject information, and the intensity distribution information; and outputting a determination result determined by the determining.

### Advantageous Effects

A determination device and the like, each according to one aspect of the present disclosure, is capable of more accurately determining whether a predetermined object is included in a subject.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a determination system and the like according to an embodiment.

FIG. 2 is a schematic diagram illustrating an example of a sub-terahertz wave image captured by an imager of the determination system in FIG. 1.

FIG. 3 is a schematic diagram illustrating an example of a subject detector of the determination system in FIG. 1.

FIG. 4 is a schematic diagram illustrating an example of intensity distribution information stored in a storage of the determination system in FIG. 1.

FIG. 5 is a schematic diagram for explaining an intensity of a sub-terahertz wave reflected by a reflector.

FIG. 6 is a flowchart illustrating an example of the operation of a determination device of the determination system in FIG. 1.

### DESCRIPTION OF EMBODIMENTS

### Outline of the Present Disclosure

An overview of one aspect of the present disclosure is as follows.

A determination device according to one aspect of the present disclosure includes: an image obtainer that obtains an image based on a sub-terahertz wave that has irradiated a predetermined region; a subject information obtainer that obtains subject information including position information indicating a position of a subject located in the predetermined region; an intensity distribution information obtainer that obtains intensity distribution information indicating an intensity distribution in the predetermined region of the sub-terahertz wave that has irradiated the predetermined region; a determiner that determines whether a predetermined object is included in the subject, based on the image, the subject information, and the intensity distribution information; and an outputter that outputs a determination result determined by the determiner.

In the present specification, the “sub-terahertz wave” means an electromagnetic wave having a frequency of 0.05 THz or more and 2 THz or less. The sub-terahertz wave in the present specification may be an electromagnetic wave having a frequency of 0.08 THz or more and 1 THz or less.

With this configuration, the position of the subject is known from the subject information, and how much intensity of the sub-terahertz wave is irradiating the subject is known from the intensity distribution information. Therefore, even if the intensity distribution of the sub-terahertz wave irradiating the predetermined region is uneven, whether the predetermined object is included in the subject can be appropriately determined according to the intensity of the sub-terahertz wave irradiating the subject, thus enabling more accurate determination of whether the predetermined object is included in the subject.

For example, the determiner may correct the image based on the subject information and the intensity distribution information, and determine whether the predetermined object is included in the subject, based on the corrected image.

With this configuration, although the intensity distribution of the sub-terahertz wave irradiating the predetermined region varies depending on the position of the subject, the image can be corrected based on the intensity distribution of the sub-terahertz wave corresponding to the position of the subject, and whether the predetermined object is included in the subject can be determined based on the corrected image, thus enabling more accurate determination of whether the predetermined object is included in the subject.

For example, the subject information may further include orientation information indicating the orientation of the subject. With this configuration, although the intensity distribution of the sub-terahertz wave irradiating the predetermined region varies depending on the orientation of the subject, the orientation of the subject is known from the subject information, thus enabling more accurate determination of whether the predetermined object is included in the subject.

For example, the determiner may determine a learning model for determining whether the predetermined object is included in the subject, based on the subject information and the intensity distribution information, and determine whether the predetermined object is included in the subject by using the determined learning model.

With this configuration, whether the predetermined object is included in the subject can be determined using the learning model corresponding to the intensity of the sub-terahertz wave irradiating the subject, thus enabling more accurate determination of whether the predetermined object is included in the subject.

For example, the determiner may determine a threshold for determining whether the predetermined object is included in the subject, based on the subject information and the intensity distribution information, and determine whether the predetermined object is included in the subject by using the determined threshold. With this configuration, whether the predetermined object is included in the subject can be determined using the threshold corresponding to the intensity of the sub-terahertz wave irradiating the subject, thus enabling more accurate determination of whether the predetermined object is included in the subject.

For example, the predetermined region may be a region located between a pair of reflective plates, each of which diffusely reflects the sub-terahertz wave.

In the present specification, the term “diffuse reflection” means that a sub-terahertz wave incident on the reflective plate at a single microscopic incident angle is reflected at a plurality of reflection angles by the structure of the concavo-convex surface having a plurality of microscopic concavities and convexities.

With this configuration, the sub-terahertz wave can be diffusely reflected, and the predetermined region can be uniformly irradiated with the sub-terahertz wave by diffusely reflecting the sub-terahertz wave, thus enabling more accurate determination of whether the predetermined object is included in the subject.

For example, a storage that stores the intensity distribution information may further be provided, and the intensity distribution information obtainer obtains the intensity distribution information from the storage.

This can facilitate the obtainment of intensity distribution information.

For example, the intensity distribution may indicate the intensity of the sub-terahertz wave at each position in the predetermined region.

With this configuration, the intensity of the sub-terahertz wave at each position in the predetermined region is known, and how much intensity of the sub-terahertz wave is irradiating the subject is known, thus enabling more accurate determination of whether the predetermined object is included in the subject.

For example, a determination method according to one aspect of the present disclosure includes: obtaining an image based on a sub-terahertz wave that has irradiated a predetermined region; obtaining subject information including position information indicating a position of a subject located in the predetermined region; intensity distribution information indicating an intensity distribution in the predetermined region of the sub-terahertz wave that has irradiated the predetermined region; determining whether a predetermined object is included in the subject, based on the image, the subject information, and the intensity distribution information; and outputting a determination result determined by the determining.

With this approach, similar operational effects to those of the above determination device are achieved.

For example, the determination device may include: an image obtainer that obtains an image based on a sub-terahertz wave that has irradiated a predetermined region; a subject information obtainer that obtains subject information including position information indicating a position of a subject located in the predetermined region and orientation information indicating an orientation of the subject; an intensity distribution information obtainer that obtains intensity distribution information indicating an intensity distribution in the predetermined region of the sub-terahertz wave that has irradiated the predetermined region; a determiner that determines whether a predetermined object is included in the subject, based on the image, the subject information, and the intensity distribution information; and an outputter that outputs a determination result determined by the determiner.

For example, the intensity distribution information may indicate a plurality of intensities of the sub-terahertz wave at respective positions in the predetermined region when the sub-terahertz wave that has irradiated the predetermined region is reflected by the same object facing a predetermined direction.

For example, the determiner may correct the intensity of the sub-terahertz wave at each of a plurality of points on the subject in the image, based on the subject information and the intensity distribution information, and determine whether the predetermined object is included in the subject, based on the corrected image.

For example, the determiner may obtain, based on the subject information and the intensity distribution information, the intensity of the sub-terahertz wave irradiating the subject at each of a plurality of points, determine a learning model for determining whether the predetermined object is included in the subject, and determine whether the predetermined object is included in the subject by using the determined learning model.

For example, the determiner may include a plurality of learning models corresponding to a plurality of intensities of the sub-terahertz wave, and determine the learning model according to the obtained intensity of the sub-terahertz wave.

For example, the determiner may obtain, based on the subject information and the intensity distribution information, the intensity of the sub-terahertz wave irradiating the subject at each of a plurality of points, determine a threshold for determining whether the predetermined object is included in the subject with respect to each of the plurality of points on the subject, and determine whether the predetermined object is included in the subject by using the determined threshold.

For example, in a case where the threshold when the subject is irradiated with the sub-terahertz wave at a predetermined intensity is a first threshold, the determiner may calculate a second threshold as the threshold based on the intensity of the sub-terahertz wave obtained, the predetermined intensity, and the first threshold.

For example, the predetermined region may be a region located between a pair of reflective plates, each of which diffusely reflects the sub-terahertz wave.

For example, a storage that stores the intensity distribution information may further be provided, and the intensity distribution information obtainer may obtain the intensity distribution information from the storage.

For example, the determination method may include: obtaining an image based on a sub-terahertz wave that has irradiated a predetermined region; obtaining subject information including position information indicating a position of a subject located in the predetermined region and orientation information indicating an orientation of the subject; intensity distribution information indicating an intensity distribution in the predetermined region of the sub-terahertz wave that has irradiated the predetermined region; determining whether a predetermined object is included in the subject, based on the image, the subject information, and the intensity distribution information; and outputting a determination result determined by the determining.

Hereinafter, an exemplary embodiment will be described below with reference to the drawings.

Note that an exemplary embodiment described below shows a general or specific example. The numerical values, shapes, materials, components, arrangement positions and connection forms of the components, steps, the order of the steps, and the like shown in the following exemplary embodiment are examples and are not intended to limit the present disclosure.

In the present specification, terms indicating relationships between elements, such as “parallel”, terms indicating the shape of an element, such as “flat”, and terms indicating time, such as “immediately after”, as well as numerical ranges, are not expressions that express only strict meanings, but expressions that also mean substantially equivalent ranges, including differences of about a few percent, for example.

Each of the drawings is not necessarily strictly illustrated. In the drawings, substantially the same components are denoted by the same reference numerals, and duplicated description is omitted or simplified.

### Embodiment

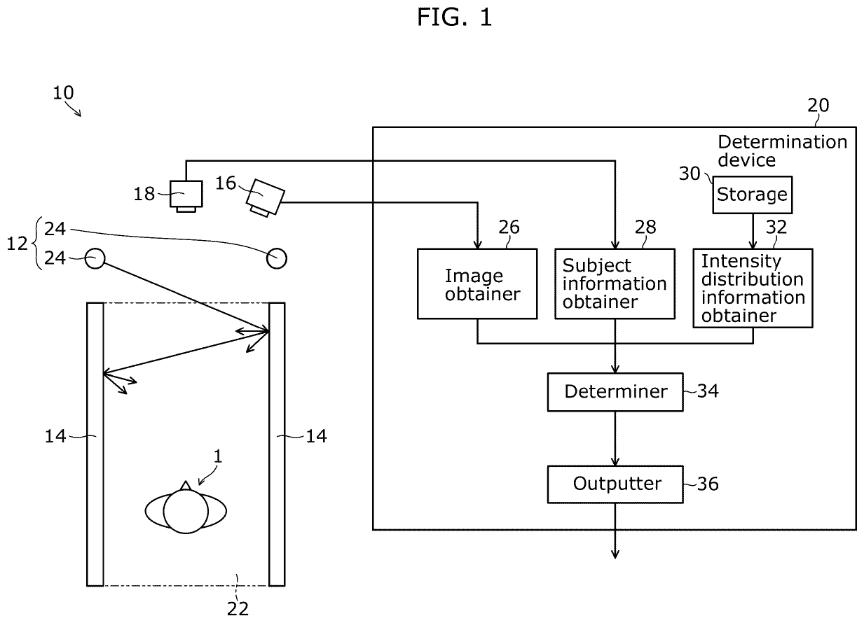

FIG. 1 is a schematic diagram illustrating determination system 10 and the like according to the embodiment.

Determination system 10 is a system that determines whether a predetermined object is included in subject 1. For example, subject 1 includes a person and an object possessed by the person. For example, the predetermined object includes a metal object, a combustible object, and the like. That is, for example, determination system 10 determines whether a person is in possession of a metal object, whether a person is in possession of a combustible object, and the like. As illustrated in FIG. 1, determination system 10 includes irradiator 12, a pair of reflective plates 14, imager 16, subject detector 18, and determination device 20.

Irradiator 12 irradiates predetermined region 22 with a sub-terahertz wave. Predetermined region 22 is a three-dimensional region. In the present embodiment, irradiator 12 includes a plurality of light sources 24. Each of the plurality of light sources 24 irradiates predetermined region 22 with a sub-terahertz wave. For example, irradiator 12 may include one light source 24 instead of the plurality of light sources 24.

In the present embodiment, predetermined region 22 is a region located between a pair of reflective plates 14. Each of the pair of reflective plates 14 diffusely reflects the sub-terahertz wave. Specifically, each of the pair of reflective plates 14 diffusely reflects the sub-terahertz wave incident from at least the side of predetermined region 22 (that is, the inside of the pair of reflective plates 14). In the present embodiment, the sub-terahertz wave emitted from irradiator 12 is diffusely reflected one or more times by at least one of the pair of reflective plates 14 to irradiate subject 1 located within predetermined region 22. In this manner, predetermined region 22 is located between the pair of reflective plates 14 that diffusely reflect the sub-terahertz wave as described above, thereby making it easier for the sub-terahertz wave that has irradiated predetermined region 22 to remain and enabling irradiation of subject 1 with the sub-terahertz wave from various angles. For example, each of the pair of reflective plates 14 may be flat or curved. For example, predetermined region 22 may not be located between the pair of reflective plates 14, and subject 1 may be directly irradiated with the sub-terahertz wave emitted from irradiator 12 including a plurality of light sources 24.

Imager 16 captures an image based on the sub-terahertz wave that has irradiated predetermined region 22. Hereinafter, an image based on the sub-terahertz wave that has irradiated predetermined region 22 may be referred to as a sub-terahertz wave image. For example, imager 16 is a camera formed of an image sensor (not illustrated), an optical system (not illustrated), and the like. For example, the image sensor is formed of a plurality of pixels, each including a sub-terahertz wave detection element, a peripheral circuit, and the like.

Imager 16 receives the sub-terahertz wave that has irradiated predetermined region 22 from irradiator 12 and has been reflected by Imager 16 performs exposure at the timing when subject 1. irradiator 12 is emitting the sub-terahertz wave, and detects the intensity of the received sub-terahertz wave. Imager 16 converts the image of the sub-terahertz wave emitted from subject 1 during the exposure into an electric signal corresponding to the intensity, and generates an image based on the converted electric signal. The image generated by imager 16 is output to image obtainer 26.

The sub-terahertz wave transmits through clothes, bags, and the like, and is specularly reflected by the human body, metal, and the like. Thus, imager 16 receives the sub-terahertz wave specularly reflected by the human body, metal, and the like included in subject 1 from a region within an angular range where imager 16 can receive the wave. For example, when a person included in subject 1 conceals an object such as a knife or a container containing combustible materials under clothes, in a bag, or the like, imager 16 receives the sub-terahertz wave specularly reflected by the concealed object from a region within an angular range where imager 16 can receive the wave.

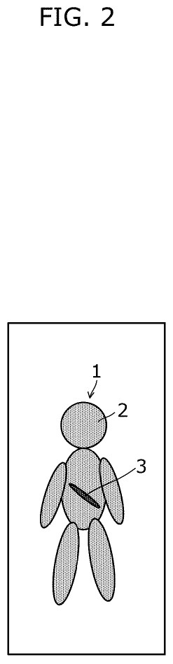

FIG. 2 is a schematic diagram illustrating an example of a sub-terahertz wave image captured by imager 16 of determination system 10 in FIG. 1.

As illustrated in FIG. 2, for example, when person 2 and predetermined object 3 are included in subject 1, the intensity of the sub-terahertz wave reflected by person 2 differs from the intensity of the sub-terahertz wave reflected by predetermined object 3.

Therefore, person 2 and predetermined object 3 appearing in the sub-terahertz wave image can be distinguished using the intensities of the sub-THz waves in the sub-terahertz wave image, thus enabling determination of whether predetermined object 3 is included in subject 1.

Returning to FIG. 1, subject detector 18 detects subject 1 located in predetermined region 22. For example, subject detector 18 detects the position and orientation of subject 1 located in predetermined region 22. For example, the position of subject 1 is the position of the reflective surface of a part of subject 1 that reflects the sub-terahertz wave. For example, the orientation of subject 1 is the orientation of the reflective surface of a part of subject 1 that reflects the sub-terahertz wave. Specifically, for example, the position of subject 1 is the position of a point on the reflective surface of subject 1 that reflects the sub-terahertz wave, and the orientation of subject 1 is the orientation of a normal that passes through the point and is perpendicular to a tangent at the point. For example, the position and orientation of subject 1 may be obtained by collecting the positions of points on the reflective surface of a part of subject 1 and the orientations of normals that pass through the points and are perpendicular to the tangents at the points throughout subject 1. That is, for example, the position of subject 1 may be the positions of a plurality of points on the reflective surface of subject 1, and the orientation of subject 1 may be the orientations of normals that pass through the plurality of points, respectively, and are perpendicular to the tangents at those points.

For example, subject detector 18 is a distance sensor and measures the distance to subject 1 to detect the position of subject 1. For example, the distance sensor may be a time-of-flight (ToF) camera, a monocular camera, a binocular camera, or the like. For example, subject detector 18 is a visible camera or an infrared camera and uses machine learning to detect the position and orientation of subject 1 from an image captured by the visible camera or the infrared camera. For example, subject detector 18 is a millimeter wave sensor. For example, subject detector 18 is a weight sensor and estimates the position and orientation of subject 1 based on the position where weight is applied. For example, subject detector 18 is a ceiling camera or a floor camera and estimates the position and orientation of subject 1 from an image captured by the ceiling camera or the floor camera.

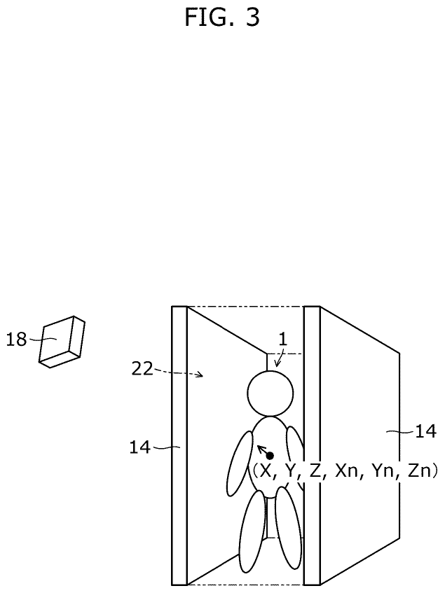

FIG. 3 is a schematic diagram illustrating an example of subject detector 18 of determination system 10 in FIG. 1.

As illustrated in FIG. 3, for example, subject detector 18 is a visible camera and detects the position and orientation of subject 1 from an image captured by the visible camera. For example, for each of one or more points on the reflective surface of subject 1, subject detector 18 detects an X-coordinate value indicating a position in the X-axis direction (see X in FIG. 3), a Y-coordinate value indicating a position in the Y-axis direction of subject 1 (see Y in FIG. 3), and a Z-coordinate value indicating a position in the Z-axis direction of subject 1 (see Z in FIG. 3). For example, for each of the one or more points, subject detector 18 detects an X-vector indicating an X-axis component of a normal vector passing through the point and perpendicular to a tangent at the point (see Xn in FIG. 3), a Y-vector indicating a component in the Y-axis direction (see Yn in FIG. 3), and a Z-vector indicating a component in the Z-axis direction (see Zn in FIG. 3).

Returning to FIG. 1, determination device 20 includes image obtainer 26, subject information obtainer 28, storage 30, intensity distribution information obtainer 32, determiner 34, and outputter 36.

Image obtainer 26 obtains an image based on a sub-terahertz wave that has irradiated predetermined region 22. In the present embodiment, image obtainer 26 obtains the sub-terahertz wave image captured by imager 16.

Subject information obtainer 28 obtains subject information. For example, the subject information includes position information indicating the position of subject 1 located in predetermined region 22 and orientation information indicating the orientation of subject 1 located in predetermined region 22. In the present embodiment, the subject information includes position information indicating the position of subject 1 detected by subject detector 18 and orientation information indicating the orientation of subject 1 detected by subject detector 18. That is, in the present embodiment, the position information includes an X-coordinate value, a Y-coordinate value, and a Z-coordinate value of each of one or more points on the reflective surface of subject 1, and the orientation information includes an X-vector indicating an X-axis component of a normal vector passing through the point and perpendicular to a tangent at the point, a Y-vector indicating a component in the Y-axis direction, and a Z-vector indicating a component in the Z-axis direction.

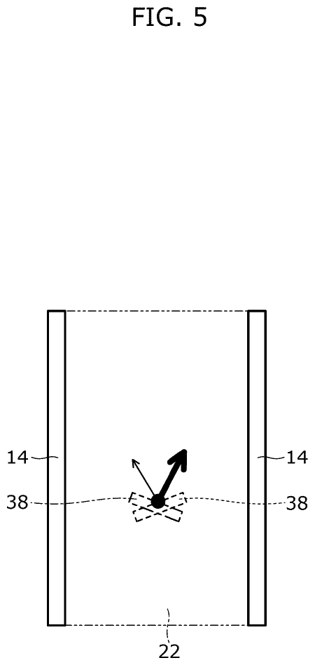

Storage 30 stores intensity distribution information. The intensity distribution information indicates an intensity distribution in predetermined region 22 of the sub-terahertz wave that has irradiated predetermined region 22. The intensity distribution indicates the intensity of the sub-terahertz wave at each position in predetermined region 22. The intensity distribution of the sub-terahertz wave that has irradiated predetermined region 22 is previously measured by simulation, experiment, or the like. For example, by irradiating predetermined region 22 with the sub-terahertz wave while reflector 38 (see FIG. 5) for reflecting the sub-terahertz wave is placed at a certain position in predetermined region 22 in a certain orientation, it is possible to measure the intensity distribution in predetermined region 22 of the sub-terahertz wave when predetermined region 22 is irradiated with the sub-terahertz wave while reflector 38 is positioned at the certain position in the certain orientation. For example, reflector 38 is a flat plate, a person, or the like.

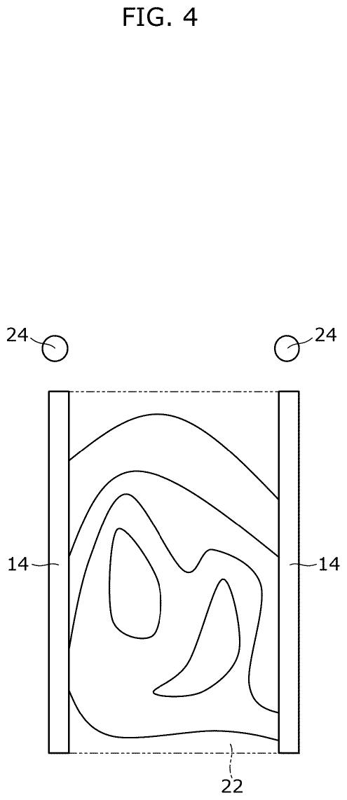

FIG. 4 is a schematic diagram illustrating an example of intensity distribution information stored in storage 30 of determination system 10 in FIG. 1.

As illustrated in FIG. 4, by irradiating predetermined region 22 with the sub-terahertz wave while reflector 38 for reflecting the sub-terahertz wave is positioned at a certain position in predetermined region 22 in a certain orientation (for example, a direction in which subject 1 travels in predetermined region 22), it is possible to measure the intensity distribution in predetermined region 22 of the sub-terahertz wave when predetermined region 22 is irradiated with the sub-terahertz wave while reflector 38 is positioned at the certain position in the certain orientation.

FIG. 5 is a schematic diagram for explaining the intensity of the sub-terahertz wave reflected by reflector 38.

As illustrated in FIG. 5, even if the position of reflection by reflector 38 is the same, the intensity of the sub-terahertz wave reflected by reflector 38 differs (see arrows in FIG. 5) due to different orientations of reflector 38 (see broken line and dash-dotted line in FIG. 5). Therefore, more intensity distributions can be obtained in the following manner: for example, reflectors 38 are positioned at as many positions as possible in predetermined region 22, and the intensity distribution of the sub-terahertz wave is measured in advance when predetermined region 22 is irradiated with the sub-terahertz wave while reflectors 38 are positioned at the respective positions; also, for example, reflectors 38 are positioned in as many orientations as possible, and the intensity distribution of the sub-terahertz wave is measured in advance when predetermined region 22 is irradiated with the sub-terahertz wave while reflectors 38 are positioned in the respective orientations.

Returning to FIG. 1, intensity distribution information obtainer 32 obtains intensity distribution information indicating the intensity distribution in predetermined region 22 of the sub-terahertz wave that has irradiated predetermined region 22. In the present embodiment, intensity distribution information obtainer 32 obtains intensity distribution information stored in storage 30. In the present embodiment, intensity distribution information obtainer 32 obtains intensity distribution information from storage 30.

Determiner 34 determines whether the predetermined object is included in subject 1, based on the sub-terahertz wave image, the subject information, and the intensity distribution information.

Conventionally, for example, when the intensity of the sub-terahertz wave in subject 1 appearing in the sub-terahertz wave image is greater than the upper threshold or less than the lower threshold, it is determined that the predetermined object is included in subject 1. When the intensity of the sub-terahertz wave in subject 1 appearing in the sub-terahertz wave image is less than the upper threshold and greater than the lower threshold, it is determined that the predetermined object is not included in subject 1.

However, it is difficult to uniformly irradiate predetermined region 22 with the sub-terahertz wave, and a portion where the intensity of the sub-terahertz wave is relatively high and a portion where the intensity of the sub-terahertz wave is relatively low may occur in predetermined region 22.

For example, when subject 1 is located in a portion where the intensity of the sub-terahertz wave is relatively high in predetermined region 22, the intensity of the sub-terahertz wave in subject 1 appearing in the sub-terahertz wave image becomes high, and the intensity of the sub-terahertz wave in subject 1 appearing in the sub-terahertz wave image may exceed the upper threshold even though the predetermined object is not included in subject 1. This can lead to a determination that the predetermined object is included in subject 1, although the predetermined object is not included in subject 1.

For example, when subject 1 is located in a portion where the intensity of the sub-terahertz wave in predetermined region 22 is relatively low, the intensity of the sub-terahertz wave in subject 1 appearing in the sub-terahertz wave image becomes low, and the intensity of the sub-terahertz wave in subject 1 appearing in the sub-terahertz wave image may fall below the upper threshold even though the predetermined object is included in subject 1. This can lead to a determination that the predetermined object is not included in subject 1, although the predetermined object is included in subject 1.

Therefore, determiner 34 uses not only the sub-terahertz wave image but also the subject information and the intensity distribution information to determine whether the predetermined object is included in subject 1.

For example, determiner 34 corrects the sub-terahertz wave image based on the subject information and the intensity distribution information, which indicates the intensity distribution in predetermined region 22 of the sub-terahertz wave that has irradiated predetermined region 22 when subject 1 is not in predetermined region 22, and determines whether the predetermined object is included in subject 1, based on the corrected sub-terahertz wave image.

For example, determiner 34 first obtains the position and orientation of subject 1 from the subject information, and then obtains the intensity distribution of the sub-terahertz wave when predetermined region 22 is irradiated with the sub-terahertz wave while reflector 38 is positioned at that position in that orientation. As described above, the intensity distribution is measured in advance by simulation, experiment, or the like, and is stored in storage 30. For example, determiner 34 may obtain only the position out of the position and orientation of subject 1 from the subject information, and obtain the intensity distribution of the sub-terahertz wave when predetermined region 22 is irradiated with the sub-terahertz wave while reflector 38 is positioned at that position. For example, determiner 34 may obtain the intensity distribution in predetermined region 22 of the sub-terahertz wave that has irradiated predetermined region 22 when subject 1 is not in predetermined region 22.

For example, among a plurality of pixels constituting the sub-terahertz wave image, determiner 34 does not correct the intensity of a first pixel representing a portion with a predetermined first intensity in the obtained intensity distribution, but corrects the intensity of a second pixel representing a portion with a second intensity different from the first intensity in the obtained intensity distribution by multiplying by the ratio (first intensity)/(second intensity). Specifically, determiner 34 decreases the intensity of the second pixel when the second intensity is higher than the first intensity, and increases the intensity of the second pixel when the second intensity is lower than the first intensity. As a result, determiner 34 can obtain a sub-terahertz wave image as if predetermined region 22 is uniformly irradiated with the sub-terahertz wave.

For example, determiner 34 determines that the predetermined object is included in subject 1 when there is a portion where the intensity of the sub-terahertz wave is greater than the upper threshold in subject 1 appearing in the corrected sub-terahertz wave image. For example, determiner 34 determines that the predetermined object is included in subject 1 when there is a portion where the intensity of the sub-terahertz wave is less than the lower threshold in subject 1 appearing in the corrected sub-terahertz wave image. For example, determiner 34 determines that the predetermined object is not included in subject 1 when there is neither a portion where the intensity of the sub-terahertz wave is greater than the upper threshold nor a portion where the intensity of the sub-terahertz wave is less than the lower threshold in subject 1 appearing in the corrected sub-terahertz wave image.

For example, determiner 34 determines a learning model for determining whether the predetermined object is included in subject 1, based on the subject information and the intensity distribution information, and determines whether the predetermined object is included in subject 1 by using the determined learning model.

For example, determiner 34 first obtains the position and orientation of subject 1 from the subject information, and then obtains the intensity distribution of the sub-terahertz wave when predetermined region 22 is irradiated with the sub-terahertz wave while reflector 38 is positioned at that position in that orientation. As described above, the intensity distribution is measured in advance by simulation, experiment, or the like, and is stored in storage 30. For example, determiner 34 may obtain only the position out of the position and orientation of subject 1 from the subject information, and obtain the intensity distribution of the sub-terahertz wave when predetermined region 22 is irradiated with the sub-terahertz wave while reflector 38 is positioned at that position.

For example, subsequently, determiner 34 obtains the intensity of the sub-terahertz wave irradiating subject 1 from the obtained intensity distribution, and determines a learning model based on the obtained intensity. For example, a plurality of learning models have been generated, each according to the intensity of the sub-terahertz wave, and determiner 34 determines the learning model corresponding to the obtained intensity. For example, each of the plurality of learning models is a model learned to output a result indicating whether the predetermined object is included in subject 1 when a sub-terahertz wave image is input.

For example, when a sub-terahertz wave image is input to the learning model determined by determiner 34, and the learning model outputs a result indicating that the predetermined object is included in subject 1, determiner 34 determines that the predetermined object is included in subject 1. For example, when a sub-terahertz wave image is input to the learning model determined by determiner 34, and the learning model outputs a result indicating that the predetermined object is not included in subject 1, determiner 34 determines that the predetermined object is not included in subject 1.

For example, determiner 34 determines a threshold for determining whether the predetermined object is included in subject 1, based on the subject information and the intensity distribution information, and determines whether the predetermined object is included in subject 1 by using the determined threshold.

For example, determiner 34 first obtains the position and orientation of subject 1 from the subject information, and then obtains the intensity distribution of the sub-terahertz wave when predetermined region 22 is irradiated with the sub-terahertz wave while reflector 38 is positioned at that position in that orientation. As described above, the intensity distribution is measured in advance by simulation, experiment, or the like, and is stored in storage 30. For example, determiner 34 may obtain only the position out of the position and orientation of subject 1 from the subject information, and obtain the intensity distribution of the sub-terahertz wave when predetermined region 22 is irradiated with the sub-terahertz wave while reflector 38 is positioned at that position.

For example, subsequently, determiner 34 obtains the intensity of the sub-terahertz wave irradiating subject 1 from the obtained intensity distribution, and determines a threshold based on the obtained intensity. For example, when the intensity of the sub-terahertz wave irradiating subject 1 is a predetermined first intensity determiner 34 determines to use the predetermined upper threshold and lower threshold. For example, when the intensity of the sub-terahertz wave irradiating subject 1 is a second intensity different from the predetermined first intensity, determiner 34 determines to use, as the upper threshold, a first threshold obtained by multiplying the predetermined upper threshold by the ratio (second intensity)/(first intensity), and determines to use, as the lower threshold, a second threshold obtained by multiplying the predetermined lower threshold by the ratio (second intensity)/(first intensity).

For example, in the portion of subject 1 appearing in the sub-terahertz wave image where the intensity of the sub-terahertz wave is the first intensity, determiner 34 determines whether the intensity of the sub-terahertz wave is greater than the predetermined upper threshold, and determines whether the intensity of the sub-terahertz wave is less than the predetermined lower threshold. For example, in the portion of subject 1 appearing in the sub-terahertz wave image where the intensity of the sub-terahertz wave is the second intensity, determiner 34 determines whether the intensity of the sub-terahertz wave is greater than the first threshold, and determines whether the intensity of the sub-terahertz wave is less than the second threshold.

Outputter 36 obtains the determination result of determiner 34.

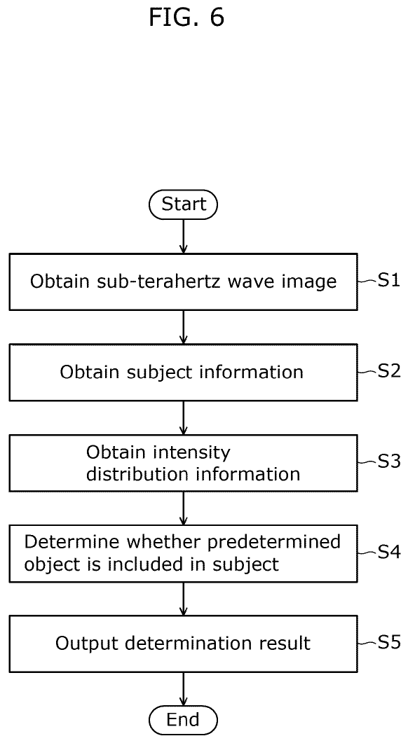

FIG. 6 is a flowchart illustrating an example of the operation of determination device 20 of determination system 10 in FIG. 1.

As illustrated in FIG. 6, image obtainer 26 obtains a sub-terahertz wave image (image obtainment step) (step S1). For example, image obtainer 26 obtains a sub-terahertz wave image as described above.

Subject information obtainer 28 obtains subject information (subject information obtainment step) (step S2). For example, subject information obtainer 28 obtains subject information as described above.

Intensity distribution information obtainer 32 obtains intensity distribution information (intensity distribution information obtainment step) (step S3). For example, intensity distribution information obtainer 32 obtains intensity distribution information as described above.

Determiner 34 determines whether the predetermined object is included in subject 1, based on the sub-terahertz wave image, the subject information, and the intensity distribution information (determination step) (step S4). For example, determiner 34 determines whether the predetermined object is included in subject 1 as described above.

Outputter 36 outputs the determination result determined by the determination step (output step) (step S5).

As described above, determination device 20 according to the embodiment includes: image obtainer 26 that obtains an image based on a sub-terahertz wave that has irradiated predetermined region 22;

subject information obtainer 28 that obtains subject information including position information indicating a position of subject 1 located in predetermined region 22; intensity distribution information obtainer 32 that obtains intensity distribution information indicating an intensity distribution in predetermined region 22 of the sub-terahertz wave that has irradiated predetermined region 22; determiner 34 that determines whether a predetermined object is included in subject 1, based on the image, the subject information, and the intensity distribution information; and outputter 36 that outputs a determination result determined by determiner 34.

With this configuration, the position of subject 1 is known from the subject information, and how much intensity of the sub-terahertz wave is irradiating subject 1 is known from the intensity distribution information. Therefore, even if the intensity distribution of the sub-terahertz wave irradiating predetermined region 22 is uneven, whether the predetermined object is included in subject 1 can be appropriately determined according to the intensity of the sub-terahertz wave irradiating subject 1, thus enabling more accurate determination of whether the predetermined object is included in subject 1.

Determiner 34 corrects an image based on the sub-terahertz wave that has irradiated predetermined region 22 on the basis of the subject information and the intensity distribution information, and determines whether the predetermined object is included in subject 1 on the basis of the corrected image.

With this configuration, although the intensity distribution of the sub-terahertz wave irradiating predetermined region 22 varies depending on the position of subject 1, the image can be corrected based on the intensity distribution of the sub-terahertz wave corresponding to the position of subject 1, and whether the predetermined object is included in subject 1 can be determined based on the corrected image, thus enabling more accurate determination of whether the predetermined object is included in subject 1.

The subject information further includes orientation information indicating the orientation of subject 1.

With this configuration, although the intensity distribution of the sub-terahertz wave irradiating predetermined region 22 varies depending on the orientation of subject 1, the orientation of subject 1 is known from the subject information, thus enabling more accurate determination of whether the predetermined object is included in subject 1.

Determiner 34 determines a learning model for determining whether the predetermined object is included in subject 1, based on the subject information and the intensity distribution information, and determines whether the predetermined object is included in subject 1 by using the determined learning model.

With this configuration, whether the predetermined object is included in subject 1 can be determined using the learning model corresponding to the intensity of the sub-terahertz wave irradiating subject 1, thus enabling more accurate determination of whether the predetermined object is included in subject 1.

Determiner 34 determines a threshold for determining whether the predetermined object is included in subject 1, based on the subject information and the intensity distribution information, and determines whether the predetermined object is included in subject 1 by using the determined threshold.

With this configuration, whether the predetermined object is included in subject 1 can be determined using the threshold corresponding to the intensity of the sub-terahertz wave irradiating subject 1, thus enabling more accurate determination of whether the predetermined object is included in subject 1. Predetermined region 22 is a region located between a pair of reflective plates 14, each of which diffusely reflects the sub-terahertz wave.

With this configuration, the sub-terahertz wave can be diffusely reflected, and predetermined region 22 can be uniformly irradiated with the sub-terahertz wave by diffusely reflecting the sub-terahertz wave, thus enabling more accurate determination of whether the predetermined object is included in subject 1.

Storage 30 that stores intensity distribution information is provided, and intensity distribution information obtainer 32 obtains intensity distribution information from storage 30.

This can facilitate the obtainment of intensity distribution information.

The intensity distribution indicates the intensity of the sub-terahertz wave at each position in predetermined region 22.

With this configuration, the intensity of the sub-terahertz wave at each position in predetermined region 22 is known, and how much intensity of the sub-terahertz wave is irradiating subject 1 is known, thus enabling more accurate determination of whether the predetermined object is included in subject 1.

A determination method according to the embodiment includes: an image obtainment step (step S1) for obtaining an image based on a sub-terahertz wave that has irradiated predetermined region 22; a subject information obtainment step (step S2) for obtaining subject information including position information indicating a position of subject 1 located in predetermined region 22; an intensity distribution information obtainment step (step S3) for obtaining intensity distribution information indicating an intensity distribution in predetermined region 22 of the sub-terahertz wave that has irradiated predetermined region 22; a determination step (step S4) for determining whether a predetermined object is included in subject 1, based on the image, the subject information, and the intensity distribution information; and an output step (step S5) for outputting a determination result determined by the determination step.

With this approach, similar operational effects to those of determination device 20 described above are achieved.

### Other Embodiments

Although the determination device according to the present disclosure has been described above based on the embodiment, the present disclosure is not limited to the embodiment. The scope of one or more aspects of the present disclosure also includes forms that can be obtained by applying various modifications, which a person skilled in the art can conceive, to the embodiment and its variations, and forms that can be implemented by any combination of the components and functions of the embodiment and its variations without departing from the gist of the present disclosure.

For example, determination system 10 may further include a reflective plate connecting the upper ends of the pair of reflective plates 14 and a reflective plate connecting the lower ends of the pair of reflective plates 14.

For example, subject 1 may not include a person and may be a luggage or the like. For example, when the luggage or the like includes the predetermined object and another object, the intensity of the reflection of the sub-terahertz wave by another object is not the same as the intensity of the reflection of the sub-terahertz wave by the predetermined object, thus enabling determination that the predetermined object is included in the luggage or the like.

For example, determination system 10 may not include all the components described in the above embodiment, but may include only the components for performing a desired operation.

In the above embodiment, each component of the determination system may be formed of dedicated hardware or may be implemented by executing a software program suitable for each component. Each component may be implemented by a program executor, such as a central processing unit (CPU) or a processor, reading and executing a software program recorded on a recording medium, such as a hard disk or a semiconductor memory.

Further, each component may be a circuit (or an integrated circuit). These circuits may constitute a single circuit as a whole or may be separate circuits. Further, these circuits may each be a general-purpose circuit or a dedicated circuit.

The general or specific aspects of the present disclosure may be implemented by a system, method, integrated circuit, computer program, or non-transitory recording medium such as a computer-readable compact disc read-only memory (CD-ROM). The present disclosure may be implemented in any combination of the system, device, method, integrated circuit, computer program, and non-temporary recording medium. For example, the present disclosure may be implemented as a program for causing a computer to execute control performed by a controller or the like included in each component of the determination system.

The order of the plurality of processes in the operation of the determination system described in the above embodiment is exemplary. The order of the plurality of processes may be changed or the plurality of processes may be executed in parallel.

In the above embodiment, various modifications, substitutions, additions, omissions, and the like can be made within the scope of the claims or their equivalents.

### Industrial Applicability

The present disclosure is broadly applicable to a determination system that determines whether a predetermined object is included in a subject.

1. A determination device comprising:
an image obtainer that obtains an image based on a sub-terahertz wave that has irradiated a predetermined region;
a subject information obtainer that obtains subject information including position information indicating a position of a subject located in the predetermined region;
an intensity distribution information obtainer that obtains intensity distribution information indicating an intensity distribution in the predetermined region of the sub-terahertz wave that has irradiated the predetermined region; and
a determiner that determines whether a predetermined object is included in the subject, based on the image, the subject information, and the intensity distribution information.

2. The determination device according to claim 1,
wherein the intensity distribution information indicates a plurality of intensities of the sub-terahertz wave at respective positions in the predetermined region when the sub-terahertz wave that has irradiated the predetermined region is reflected by a same object facing a predetermined direction.

3. The determination device according to claim 1,
wherein the determiner corrects an intensity of the sub-terahertz wave at each of a plurality of points on the subject in the image, based on the subject information and the intensity distribution information, and determines whether the predetermined object is included in the subject, based on the image corrected.

4. The determination device according to claim 1,
wherein the determiner obtains, based on the subject information and the intensity distribution information, an intensity of the sub-terahertz wave irradiating the subject at each of a plurality of points, determines a learning model for determining whether the predetermined object is included in the subject, and determines whether the predetermined object is included in the subject by using the learning model determined.

5. The determination device according to claim 4,
wherein the determiner includes a plurality of learning models corresponding to a plurality of intensities of the sub-terahertz wave, and determines the learning model in accordance with the intensity of the sub-terahertz wave obtained.

6. The determination device according to claim 1,
wherein the determiner obtains, based on the subject information and the intensity distribution information, an intensity of the sub-terahertz wave irradiating the subject at each of a plurality of points, determines a threshold for determining whether the predetermined object is included in the subject with respect to each of the plurality of points on the subject, and determines whether the predetermined object is included in the subject by using the threshold determined.

7. The determination device according to claim 6,
wherein in a case where the threshold when the subject is irradiated with the sub-terahertz wave at a predetermined intensity is a first threshold, the determiner calculates a second threshold as the threshold based on the intensity of the sub-terahertz wave obtained, the predetermined intensity, and the first threshold.

8. The determination device according to claim 1,
wherein the predetermined region is a region located between a pair of reflective plates each of which diffusely reflects the sub-terahertz wave.

9. The determination device according to claim 1, further comprising:
a storage that stores the intensity distribution information,
wherein the intensity distribution information obtainer obtains the intensity distribution information from the storage.

10. The determination device according to claim 1,
wherein the subject information further includes orientation information indicating an orientation of the subject.

11. The determination device according to claim 1, further comprising:
an outputter that outputs a determination result determined by the determiner.

12. A determination method comprising:
obtaining an image based on a sub-terahertz wave that has irradiated a predetermined region;
obtaining subject information including position information indicating a position of a subject located in the predetermined region;
obtaining intensity distribution information indicating an intensity distribution in the predetermined region of the sub-terahertz wave that has irradiated the predetermined region; and
determining whether a predetermined object is included in the subject, based on the image, the subject information, and the intensity distribution information.
